(19) United States
(12) Patent Application Publication
(10) Pub. No.: US 2005/0257819 A1
(43) Pub. Date: Nov. 24, 2005

(54) Foldable mobility support device

(76) Inventors: Phillip M. Willis, Duluth, GA (US); Christopher D. Sanders, (US)

Correspondence Address: MALLOY & MALLOY, P.A., Historic Coral Way, 2800 S.W. Third Avenue, Miami, FL, 33129, US

(21) Appl. No.: 11/129,569

(22) Filed: May 13, 2005

Related U.S. Application Data
(63) Continuation of application No. 10/680,596, filed on Oct. 7, 2003.

(51) Int. Cl. A61H 3/00; A45B 9/00

(52) U.S. Cl. 135/74

(57) ABSTRACT

A mobility device includes at least a first front leg and at least a first rear leg connected to the first front leg connected to the first front leg. The first rear leg includes an upper member having a first end a second end and a lower member having a first end and a second end. The first end of the upper member is pivotally connected to the first end of the lower member, and the lower member is preferably pivotal between an extended use position and a folded storage position.

### CLAIM OF PRIORITY

The present application is a continuation application of previously filed, now pending application having Ser. No. 10/680,596, filed on Oct. 7, 2003 incorporated herein by reference.

### BACKGROUND OF THE INVENTION

1. Field of the Invention

The present invention generally relates to mobility support devices. More particularly, the invention relates to a foldable walker, in preferred embodiments.

2. Description of the Related Art

Elderly persons, disabled persons, surgery patients, etc., often require assistance when attempting to walk or move about. Walkers and canes are two devices typically used to provide such assistance by allowing a user to support a portion of his or her weight on the device, thereby providing increased stability to the user and removing weight normally supported by the user's extremities. Of the two devices, walkers provide more stability of the user. However, due to their size and general structure, walkers are often bulky and cumbersome to transport and store.

Because walkers are frequently transported between uses, some walkers are designed to be foldable so that they are easier to handle and require less space during transportation. For example, many walkers are sized such that they would not adequately fir into the trunk of a vehicle when they are in their fully extended use positions. A foldable walker is generally more easily lifted by a user and more likely to fit adequately within a vehicle. However, the collapsibility of known walkers is limited in that the walker still must offer the structural integrity needed to support the user. As such, many existing foldable walkers only partially fold and are still considerably bulky and cumbersome to carry and store in their folded positions. Various foldable walkers also include wheels and brake assemblies that render the walker less conducive to folding. For example, it is important to ensure that any handbrakes, cables, and wheel brake assemblies are not damaged and remain in proper functioning condition as the walker is repeatedly transitioned between the folded and in-use positions.

Manufacturers and retailers may also benefit from a foldable walker that requires less storage space than those currently available. For example, from an economical standpoint, reducing the overall size of the foldable walker while in its folded position may translate into reduced shipping costs for the manufacturer. As well, reduced size requires that a retailer dedicate less shelf space to each walker being offered for sale.

From the foregoing, it can be appreciated that it would be desirable to have a stable yet foldable walker, or other device, thereby facilitating the transportation, storage, and use of the walker or device.

### SUMMARY OF THE INVENTION

Briefly described, in one embodiment, among others, a foldable walker provides an apparatus for assisting a user with mobility. An embodiment, among others, of a foldable walker includes at least a first front leg and a least a first rear leg connected to the first front leg. The first rear leg includes an upper member having a first end and a second end and a lower member having a first end and a second end. The first end of the upper member is pivotally connected the first end of the lower member, and the lower member is preferably pivotal between an extended use position and a folded storage position.

Another embodiment, among others, of a foldable walker includes a first front leg, a second front leg, and a first cross-member. Each of the first and second front legs includes a first end and a second end, and the first cross-member connects the first and second front legs. A first rear leg is connected to the first front leg, and the first rear leg includes an upper member having a first end and a second end, and a lower member having a first end and a second end, and a hinge connecting the first end of the upper member to the first end of the lower member. A second rear leg is connected to the second front leg, and the second rear leg includes an upper member having a first end and a second end, a lower member has a first end and a second end, and a hinge connecting the first end of the upper member to the first end of the lower member. The lower members of the first and second rear legs are preferably pivotal between an extended use position and a folded storage position.

Other systems, methods, features, and advantages of the present foldable walker will be or become apparent to one with skill in the art upon examination of the following drawings and detailed description. It is intended that all such additional systems, methods, features, and advantages be included within this description.

These and other objects, features and advantages of the present invention will become clearer when the drawings as well as the detailed description are taken into consideration.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front perspective view of an embodiment, among others, of a foldable walker.

FIG. 2 is a rear perspective view of the foldable walker as shown in FIG. 1.

FIG. 3 is a side view of the foldable walker shown in FIG. 1.

FIGS. 4a and 4b are front and side views of an upper portion of an embodiment of a hinge assembly as used on the foldable walker shown in FIG. 1.

FIGS. 5a and 5b are front and side views of a lower portion of an embodiment of a hinge assembly as used on the foldable walker shown in FIG. 1.

FIGS. 6a-6d are partial, cut-away side views of an embodiment of a hinge assembly, including upper and lower portions as shown in FIGS. 4a-4b and 5a-5b, respectively, as used with the foldable walker shown in FIG. 1.

FIG. 7 is a rear perspective view of the foldable walker shown in FIG. 1, in a partially folded position.

FIG. 8 is a rear perspective view of the foldable walker shown in FIG. 1, in a fully folded position.

Reference will now be made in detail to the description of the foldable walker as illustrated in the drawings. While the foldable walker will be described in connection with these drawings, there is no intent to limit it to embodiment or embodiments disclosed therein.

Like reference numerals refer to like parts throughout the several views of the drawings.

### DETAILED DESCRIPTION OF THE PREFERRED EMBODIMENT

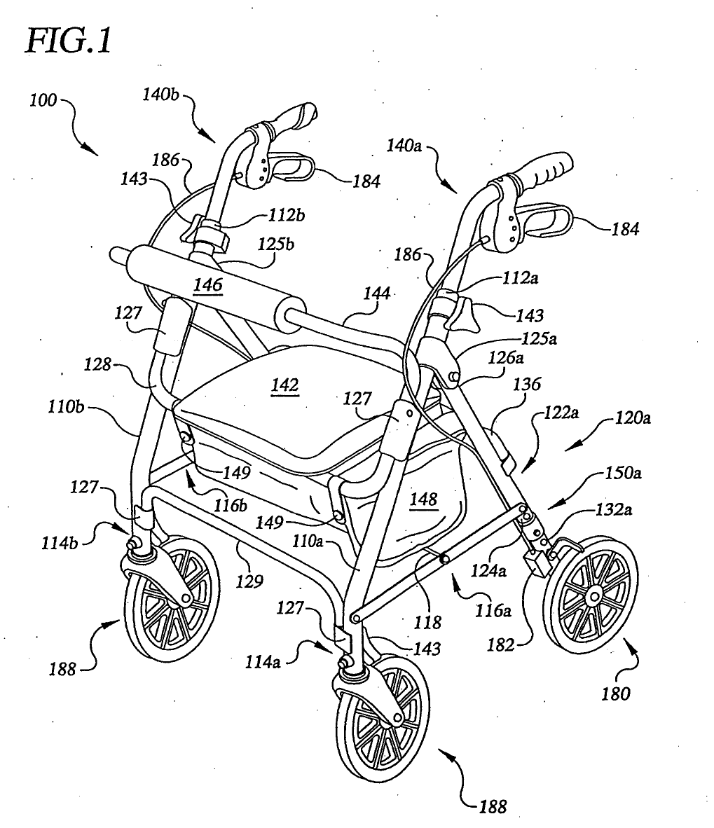

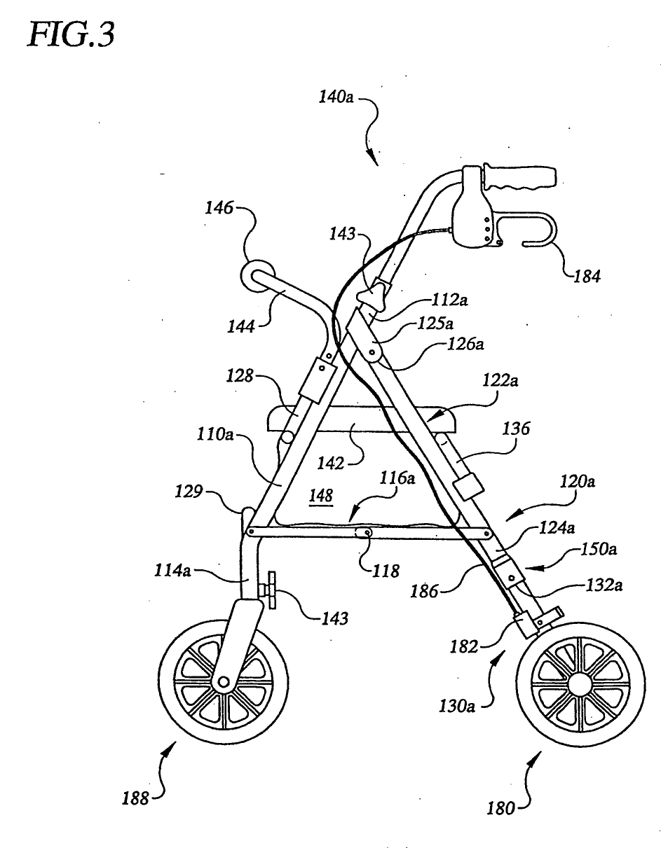

Referring now in more detail to the drawings, FIGS. 1-3 illustrate an embodiment of a foldable walker 100. As shown, the foldable walker 100 includes a first leg 110a and a second front leg 100b secured to each other by at least a first cross member 128. The first front leg 110a and a second front leg 110b are each pivotally connected to a first rear leg 120a and a second rear leg 120b, respectively. The first and second rear legs 120a, 120b each include an upper member 122a, 122b hingably attached to a respective lower member 130a, 130b by hinge assemblies 150a, 150b, respectively, as is discussed in greater detail hereinafter. Preferably, the first upper member 122a and a second upper member 122b are connected by a second cross member 136 which is positioned so as to be the same height above a support surface beneath the foldable walker 100 as the first cross member 128. Additional cross members, such ad cross member 129, may (though not necessarily in all embodiments) be provided between the first and second front legs 110a, 110b and the first and second upper members 122a, 122b to provide additional stability to the foldable walker 100. Preferably, the first cross member 128, the second cross member 136, and cross member 129 are welded to brackets 127 which are in turn welded to their respective legs of the foldable walker 100. Of course, other connection structures are also considered to be within the scope of the present invention. Further, the first and front legs 110a, 110b are preferably connected to the first and second upper members 122a, 122b, respectively, by folding brackets 116a and 116b. The first and second folding brackets 116a, 116b are preferably connected to each other with a tie rod 118 and are configured such that the folding brackets 116a, 116b only collapse when the tie rod 118 is pushed upwardly away from the support surface beneath the foldable walker 100.

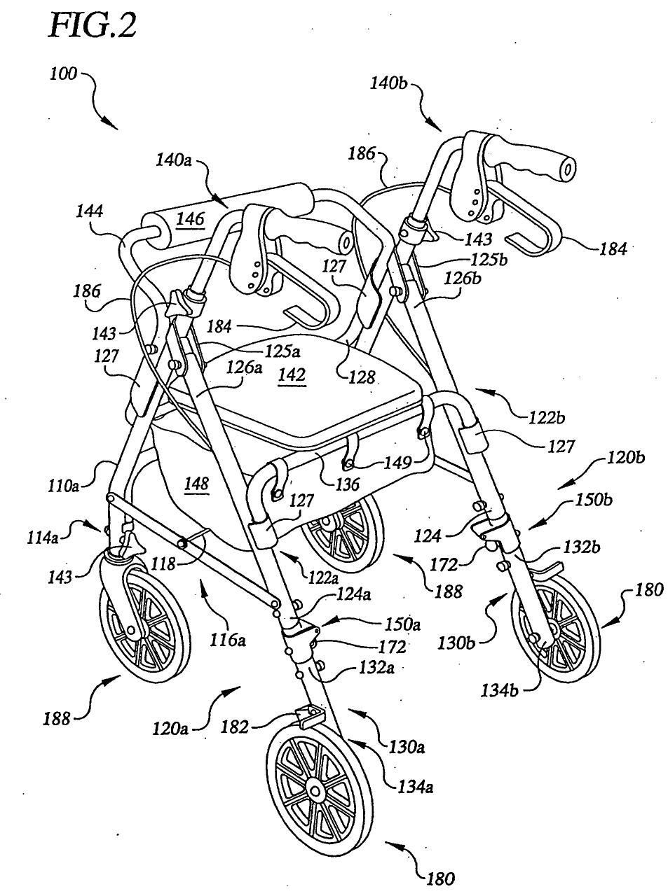

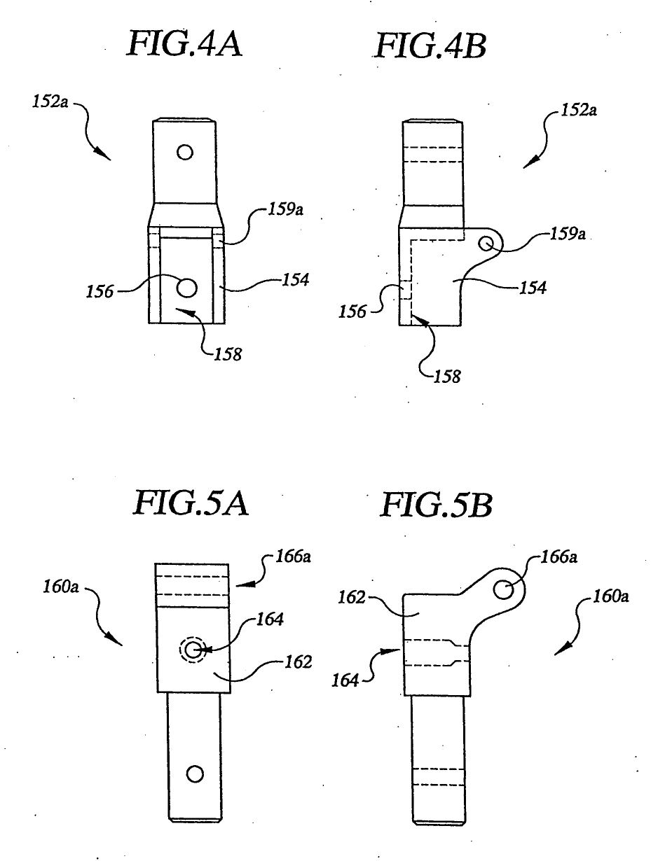

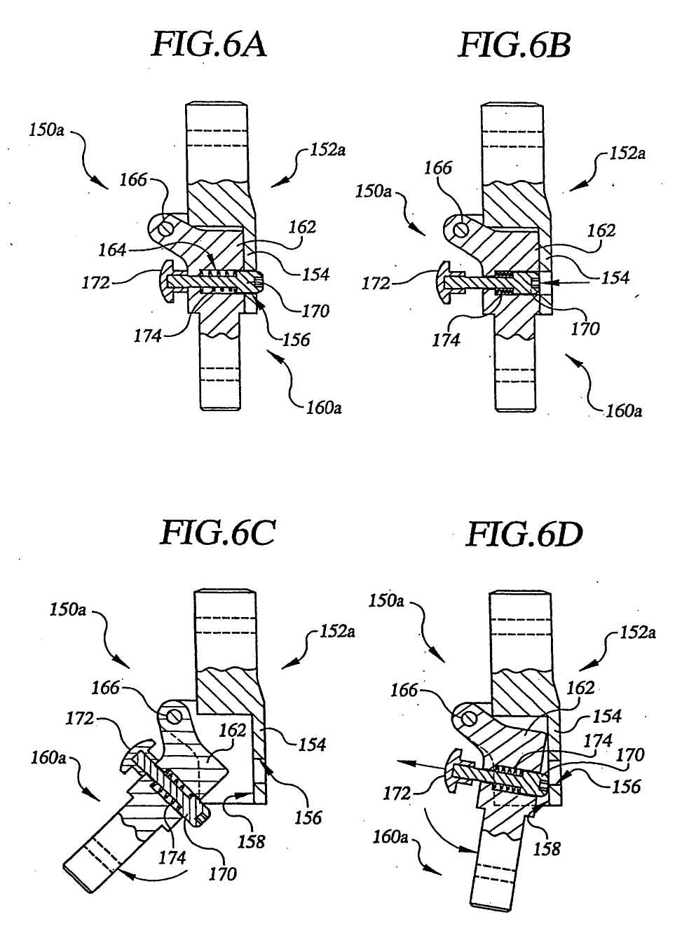

A previously noted, and as best shown in FIG. 2, the first and second upper members 122a, 122b are hingably connected to the first and second lower members 130a,130b by first and second hinge assemblies 150a, 150b, respectively. For ease of description, only the first rear leg 120a will be discussed. As shown, the second end 126a of the first upper member 122a is preferably rotatably connected through a pivot structure, such as a pivot assembly 125a, to the front leg 110a. Similarly, pivot assembly 125b rotatably connects the second end 126b to the second front leg 110b. The upper portion 152a (FIGS. 4a and 4b) of the first hinge assembly 150a is secured to the first end 124a of the upper member 122a. Similarly, the lower portion 160a (FIGS. 5a and 5b) is mounted to the first end 132a of the first lower member 130a. By passing an axle 166 through corresponding axle apertures 159a in the upper portion 152a and a corresponding axle channel 166a in the lower portion 160a, the upper and lower portions 152a, 160a are hingably secured to each other. As such, the first lower member 130a is secured to the first member 122a, as shown in FIGS. 1-3. As shown in FIGS. 6a-6d, the lower portion 160a includes a locking pin 170 that is threadably secured to a low profile button 172 to facilitate operating the first hinge assembly 150a. As well, the locking pin 170 is biased by a spring 174. Operation of the first and second hinge assembly's 150a, 150b and the foldable walker 100 are discussed in greater detail hereinafter.

Referring back to FIGS. 1-3, preferred embodiments of the foldable walker 100 may include a seat 142 supported by the first and second cross members 128, 136, and a backrest 144 supported between the first and second front legs 110a, 110b. Preferably, the seat 142 is configured to rotate about the first cross member 128 such that the seat 142 can be rotated toward the backrest 144, thereby exposing a storage compartment 148 disposed beneath the seat 142. Preferably, the storage compartment 148 is supported by the first and second cross members 128, 136. As shown, the storage compartment 148 comprises a bag secured to the first and second cross members 128, 136 with a plurality of snaps 149 that permit the storage compartment 148 to be removed. However, embodiments are envisioned wherein the storage compartment 148 comprises a wire mesh basket or other like structure. As shown, the backrest 144 includes a pad 146 for the comfort of the user.

Preferably, each leg of the foldable walker 100 includes a wheel assembly. First and second front legs 110a, 110b each include a front wheel assembly 188 disposed at the second end 114a, 114b of each leg. As shown, front wheel assemblies 188 are preferably caster-mounted such that they are fully rotatable about the first and second front legs 110a, 110b, thereby increasing the maneuverability of the foldable walker 100. The first and second rear legs 120a, 120b each include a rear wheel assembly 180 disposed on the second end 134a, 134b of the first and second lower members 130a, 130b. Preferably, the rear wheel assemblies 180 are not caster-mounted and therefore do not pivot about the first and second rear legs 120a, 120b. The first and second front legs 110a, 110b further include a first and second handlebar 140a, 140b adjustably connected to the first end 112a, 112b of each front leg 110a, 110b, respectively. Preferably, the first and second handlebars 140a, 140b are secured to the walker 100 with easily manipulated threaded knobs 143, as are other parts of the walker 100. The first and second handlebars 140a, 140b are connected to the first and second front legs 110a, 110b such that they can be adjusted based upon the height of the user. Also, each handlebar 140a, 140b includes a lever 184, which is used to activate a brake 182 that is adjacent the rear wheel assemblies 180. By urging the lever 184 upwardly toward the respective handlebar 140a, 140b, a cable 186 is pulled which in turn causes the brake 182 to engage the rear wheel assembly 180, thereby preventing the foldable walker 100 from rolling. Further, the levers 184 may be manipulated such that the brakes 182 are activated although the user is no longer exerting force on the lever 184.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Operation

As shown in FIGS. 1-3, the foldable walker 100b is configured to assist a user to walk while the first and second lower members 130a, 130b are locked in their fully extended use positions. For ease of description, only the first hinge assembly 150a is discussed. During use, first hinge assembly 150a is configured as shown in FIG. 6a, as viewed from the front of the walker 100. The core 162 of lower portion 160a is disposed within sleeve 154 of the upper portion 152a. The core 162 is secured in position by a locking pin 170 that extends through both the upper portion 152a and a lower portion 160a. As shown, when the core 162 is properly seated within the sleeve 154, a locking channel 164 that houses the locking pin 170 aligns with a locking aperture 156 formed in the sleeve 154. The locking channel 164 also houses a spring 174, which biases the locking pin 170 such that a portion of the locking pin 170 extends outwardly from the locking channel 164 and engages the locking aperture 156.

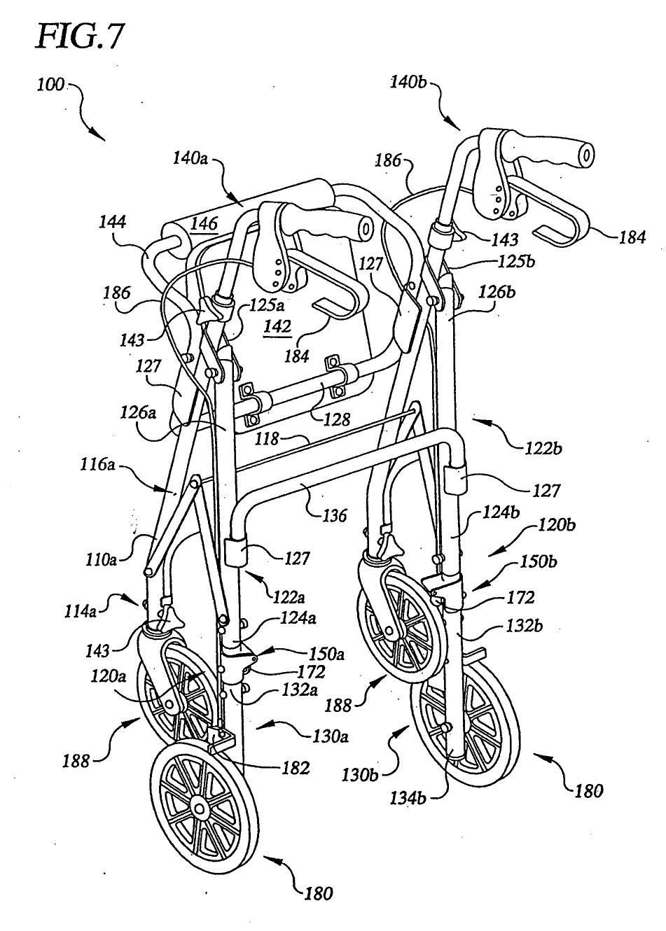

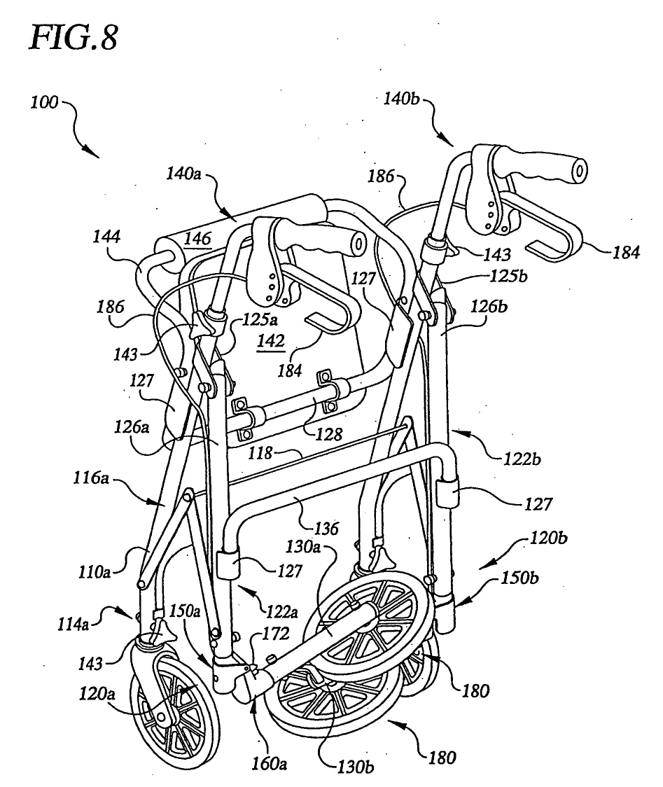

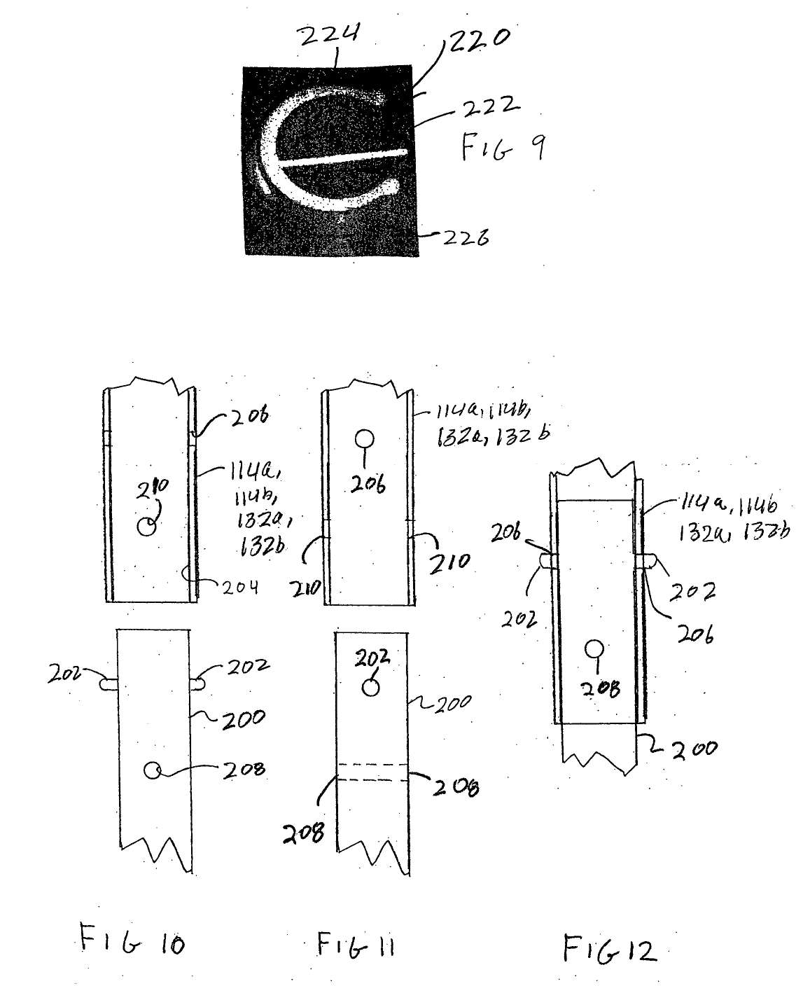

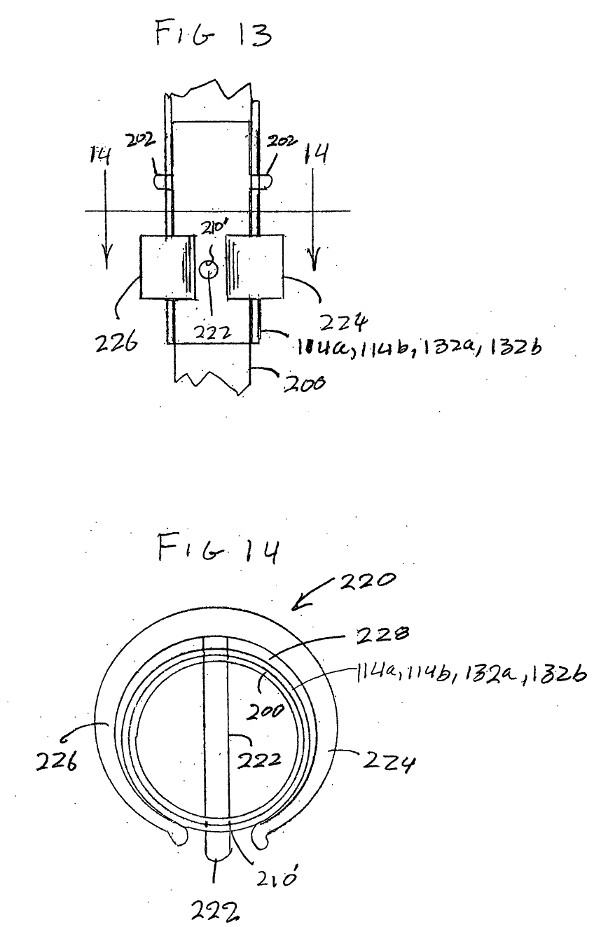

To fold the foldable walker 100, the user first pushes upwardly on one of the folding brackets 116a, 116b or the tie rod 118. As the tie rod 118 moves upwardly the first and second rear legs 120a, 120b rotate toward the first and second front legs 110a, 110b about the pivot points adjacent the second ends 126a, 126b of the first and second upper members 122a, 122b. The first and second rear legs 120a, 120b will rotate inwardly until the walker is configured in the manner shown in FIG. 7. The walker is shown in FIGS. 7 and 8 without the storage compartment 148 in order to more clearly show the folding operation.

To further reduce the overall size of the foldable walker 100, a user can fold the lower members 130a, 130b of the first and second rear legs 120a, 120b and their associated rear wheel assemblies 180 inwardly toward one another. In order to fold first lower member 130a into storage position, the user first pulls button 172 inwardly toward the center line of the foldable walker 100. In doing so, the user compresses the spring 174 and causes the locking pin 170 to be disengaged from the locking aperture 156 of the upper portion 152a, as shown in FIG. 6b. After the locking pin 170 is disengaged from the locking aperture 156 the lower portion 160a is pivotal about the axis 166 (FIG. 6c), thereby allowing lower member 130a to be swung into its storage position, as shown in FIG. 8. Similar steps are performed on the second hinge assembly 150b so that lower member 130b can be swung into its storage position.

Once a user releases the button 172, the spring 174 causes the locking pin 170 to be urged outwardly from the core 162 into its fully extended position. To lock the wheels in place for use once again, the user may pivot the first lower member 130a downwardly from its storage position until the locking pin 170 encounters camming surface 158, as shown in FIG. 6d. As lower member 130a continues to be rotated into alignment with upper member 122a, the locking pin 170 travels along the camming surface 158, subsequently causing the spring 174 to be compressed and the button 172 to be urged away from the lower portion 160a of the first hinge assembly 150a. Eventually, the locking pin 170 encounters the locking aperture 156 and extends therethrough because of the biasing effect of the spring 174, as shown in FIG. 6a. After the lower member 130b has been similarly positioned, the first and second front legs 110a, 110b and the first and second rear legs 120a, 120b are urged outwardly away from each other thereby causing folding brackets 116a, 116b to become fully extended. With the lower members 130a, 130b so positioned, the foldable walker 100 is configured to assist a user in walking.

Preferably, the locking pin 170 is configured such that it is not likely to be inadvertently disengaged from the locking aperture 156. For example, as shown in FIGS. 6a-6d, the button 172 is shaped such that it is of a low profile and is therefore not prone to being snagged or pulled during use. As well, it is preferable that the button 172 is shielded by a portion of the hinge assembly 150. As best shown in FIG. 6a, the button 172 is shielded by the portion of the hinge assembly 150a that houses the axle 166. However, the button as shown is merely one embodiment and numerous other shapes are envisioned.

It should be emphasized that the above-described embodiments of the present foldable walker 100, particularly, any “preferred” embodiments, are merely possible examples of implementations and merely set forth for a clear understanding of the principles of the foldable walker 100. Many variations and modifications may be made to the above-described embodiments(s) of the foldable walker 100 without departing substantially from the spirit and principles of the foldable walker 100. All such modifications and variations are intended to be included herein within the scope of this disclosure and the present foldable walker 100 and protected by the following claims.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A walker device structured to facilitate an individual's mobility, walker assembly comprising:
a frame selectively disposable between an operative orientation and a stored orientation,
frame including a front leg assembly and a rear leg assembly movably in a connected in relatively disposable between set operative and stored orientations,
a least one of said front or rear leg assemblies structured to have a variable length when disposed between said operative and stored orientations,
said stored orientation at least partially defined by set frame having a compact configuration of substantially reduced transfers and longitudinal dimensions

2. A walker assembly recited in claim 1 wherein said stored orientation comprises said front and rear leg assemblies disposed in adjacent, substantially aligned relation along a length of said frame and thereby at least partially defining said reduced transfers dimension.

3. A walker assembly as recited in claim 1 wherein said store orientation comprises at least one of said front or rear leg assemblies including a lower portion disposable into a folded storage position and thereby at least partially defining said reduced longitudinal dimension.

4. A walker assembly as recited claim 3 wherein said stored orientation comprises said front and rear leg assemblies disposed in adjacent substantially aligned relation along a length of said frame and thereby at least partially defining said reduced transfers dimensions.

5. A walker assembly recited in claim 1 further comprising a front wheel assembly and a rear wheel assembly respectively connected to a lower portion of each of said front and rear leg assemblies.

6. A walker assembly recited in claim 5 wherein said stored orientation comprises at least one of said front or rear wheel assemblies disposable into a folded storage position and thereby at least partially defining said reduced longitudinal dimension.

7. A walker assembly recited in claim 6 wherein said one front or rear wheel assembly is connected to said lower portion of a corresponding one of said front or rear leg assemblies and movable therewith into said folded storage position.

8. A walker assembly as recited in claim 7 wherein said stored orientation further comprises the other of said front or rear wheel assemblies removed from the corresponding one of said front or rear leg assemblies.

9. A walker assembly recited in claim 6 wherein said stored orientation further comprises the other of said front or rear wheel assemblies removed from the other of said front or rear led assemblies.

10. A walker assembly as recited in claim 1 further comprising a handle assembly adjustably connected to at least one of said front or rear leg assemblies.

11. A walker assembly as recited in claim 10 wherein said stored orientation further comprises said handle assembly removed from said frame and thereby further defining said reduced longitudinal configuration.

12. A walker assembly as recited in claim 1 further comprising a hinge assembly pivotally interconnecting a lower portion and an upper portion of at least one of said front and rear leg assemblies, said hinge assembly structured to facilitate disposition of said lower portion between a folded storage position and an extended use position.

13. A walker assembly recited in claim 12 wherein said hinge assembly comprising a spring bias locking pin disposed to extend through both said upper portion and said lower portion such that said lower portion is removably secured in said extended use position.

14. A walker assembly as recite din claim 1 wherein said operative orientation comprises said front and rear leg assemblies movably connected and disposed in space, angularly oriented relation to one another.

15. A walker assembly as recited in claim 2 wherein said stored orientation comprises said front and rear leg assemblies disposed in adjacent, substantially aligned relation along a length of said frame and thereby at least partially defining said reduced transfers dimension.

16. A walker assembly as recite din claim 15 further comprising a front wheel assembly and a rear wheel assembly respectively connected to a lower portion of each of said front and rear leg assemblies.

17. A walker assembly as recite din claim 16 wherein at least one of said front or rear assemblies is connected to said lower portion of a corresponding one of said front or rear leg assemblies and movable therewith into said folded storage position.

18. A walker assembly structured to facilitate an individual mobility, said walker assembly comprising:
a frame selectively disposable between an operative orientation and a stored orientation,
said frame including a front leg assembly and a rear leg assembly movably in a connected and relatively disposable between said operable and stored orientations,
said operative orientation comprising said front and rear leg assemblies movably connected and disposed in space, angularly oriented relation to one another,
said stored orientation comprising said front and rear leg assemblies disposed in adjacent, substantially aligned relation along a length of said frame,
a front wheel assembly and a rear wheel assembly respectively connected to a lower portion of each of said front and rear leg assemblies, and
said stored orientation at least partially defined by said frame assuming a compact configuration of substantially reduced transfers and longitudinal dimensions.

19. A walker assembly as recited in claim 19 further comprising a seat movably connected to said frame and disposable in a supporting position when said frame is in said operative orientation.

20. A frame assembly as recited in claim 20 wherein said seat is disposed in substantially aligned relation to said front and rear leg assemblies along a length of said frame when said frame is in said stored orientation and thereby at least partially defining said reduced transfers dimension.

21. A walker assembly as recited in claim 20 further comprising a storage compartment connected to said frame and disposable between an expanded position and a collapsed position when said frame is in said operative orientation and said stored orientation respectively.

22. A walker assembly as recited in claim 22 wherein said seat is disposed in substantially covering relation to an interior of said storage compartment when said frame is in said operative orientation.

23. A walker assembly as recited in claim 22 wherein said seat is disposable in confronting relation to said back rest when said frame is in said operative orientation.

24. A walker assembly as recited in claim 29 wherein said stored orientation comprises at leas one of said front or rear wheel assemblies in disposable into a folded storage position and thereby at least partially defining said reduced longitudinal dimension.

25. A walker assembly as recite din claim 25 wherein said one front or rear wheel assemblies connected to said lower portion of a corresponding one of said front or rear leg assemblies and movable therewith into said folded storage position.

26. A walker assembly as recite din claim 26 where in said stored orientation further comprises the other of said front or rear wheel assemblies removed from the other of said front or rear leg assemblies.
